(19) United States
(12) Patent Application Publication
(10) Pub. No.: US 2014/0338249 A1
(43) Pub. Date: Nov. 20, 2014

(54) Realistic Waterfowl Decoy Assembly

(71) Applicant: Charles W. Heiges, Port Clinton, OH (US)

(72) Inventor: Charles W. Heiges, Port Clinton, OH (US)

(21) Appl. No.: 13/893,380

(22) Filed: May 14, 2013

(51) Int. Cl. A01M 31/06

(52) U.S. Cl. CPC A01M 31/06
USPC 43/3

(57) ABSTRACT

A realistic looking waterfowl decoy has repositionable head and body portions to enable members of a group of decoys to be placed in a variety of positions to mimic a resting flock of real birds, for example, geese. At least portions of the bodies, as well as the necks and heads, of the decoys can have faux feathers adhered to their surfaces to more accurately simulate real waterfowl. A preferred embodiment of the decoy assembly has oblate spheroid end portions formed on attachment portions of both the legs and a keel member which allow the decoy assembly to be alternatively adapted for use both on land and in the water.

This application is a continuation-in-part of U.S. patent application Ser. No. 13/752,240 filed Jan. 28, 2013.

### BACKGROUND AND SUMMARY OF THE INVENTION

The present invention is directed to the field of hunting equipment. More particularly, the present invention is directed to a realistic waterfowl decoy of the type described and claimed in Applicant's earlier U.S. Pat. No. 5,379,063 which is hereby incorporated by reference.

To be effective, a waterfowl decoy must be as realistic as possible in order to attract birds on the wing to alight on the pond or land mass where the decoys are being utilized. Some hunters have even attempted to employ the services of a taxidermist to create a “life-like” decoy. The problem is the resulting decoy looks precisely like what it is: a dead duck (or goose). Often, instead of attracting incoming waterfowl, it alerts them to avoid the prospective landing area.

When hunting in a selected area, a group of decoys can be deployed to attract birds on the wing. The more natural and realistic the group of decoys can be made to appear, the more attractive they become. When all the decoys are deployed having identical postures, they present an unnatural appearance which the waterfowl can spot. Therefore, it is desirable to position the decoys in a variety of poses including simulating feeding, resting and other poses consistent with normal activities.

The decoy taught in the abovementioned patent had an incredibly good track record in drawing in waterfowl. Accordingly, it is among the objects of the present invention to optimize performance characteristics of that decoy without “reinventing the wheel”. In addition, it is desirable to provide the life-like decoy assembly of the present invention with the ability to be adapted for both land and water use by simply changing out a keel member for the standing base member.

The device of the present invention comprises a decoy for luring waterfowl within a hunter's range, which includes a) a body portion at least a portion of which is covered with faux feathers enhancing its similarity in physical appearance to an actual water fowl; b) a head portion interconnected to the body portion by a flexible neck which can be bent to place the head portion in a particular desired orientation emulating an actual waterfowl's head positioning when performing one action selected from the group consisting of i) feeding, ii) sleeping, iii) standing, iv) swimming and v) preening; c) a base portion interconnected to the body portion by a plurality of flexible legs which can be bent to place the body portion in a particular desired orientation consistent with the action being emulated in subpara. b). The head portion is connected to the body portion by a modified ball-and-socket positioned in a chest portion of the decoy to facilitate realistic head movement. The base portion can be removed and replaced by a keel configuring the decoy for use on a body of water. The base portion also includes a flexible section permitting wind-induced rocking motion. The rocking motion can be eliminated by engagement of latching means.

Another aspect of the present invention is decoy assembly adaptable for use on land and water, said decoy assembly comprising: a) a body portion having an appearance of a waterfowl, the body portion having at least one socket for receiving and retaining at least one removable protrusion; b) a head portion repositionable upon the body portion to simulate a variety of activities normally engaged in by the waterfowl; c) a base portion simulating legs of a waterfowl, the base portion having a first at least one protrusion for engagement in the at least one socket; d) a keel portion for stabilizing the body portion on a body of water, the keel portion having a second at least one protrusion for alternative engagement in the at least one socket; whereby the decoy may be adapted for use on land and on water.

Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals and in which

FIG. 1 is a front perspective view of a first embodiment of the realistic decoy of the present invention;

FIG. 1A is a top view of several faux feathers utilized in the decoy of the embodiments of the present invention;

FIG. 2 is a side view of in partial section of the head portion of the first embodiment;

FIG. 3 is sectional side view of a leg of the first embodiment;

FIG. 4 is side view in partial section of the head and body of a second embodiment; and,

FIG. 5 is a front perspective view of a keel usable with the decoy of the present invention.

### DETAILED DESCRIPTION OF THE PREFERRED EMBODIMENT(S)

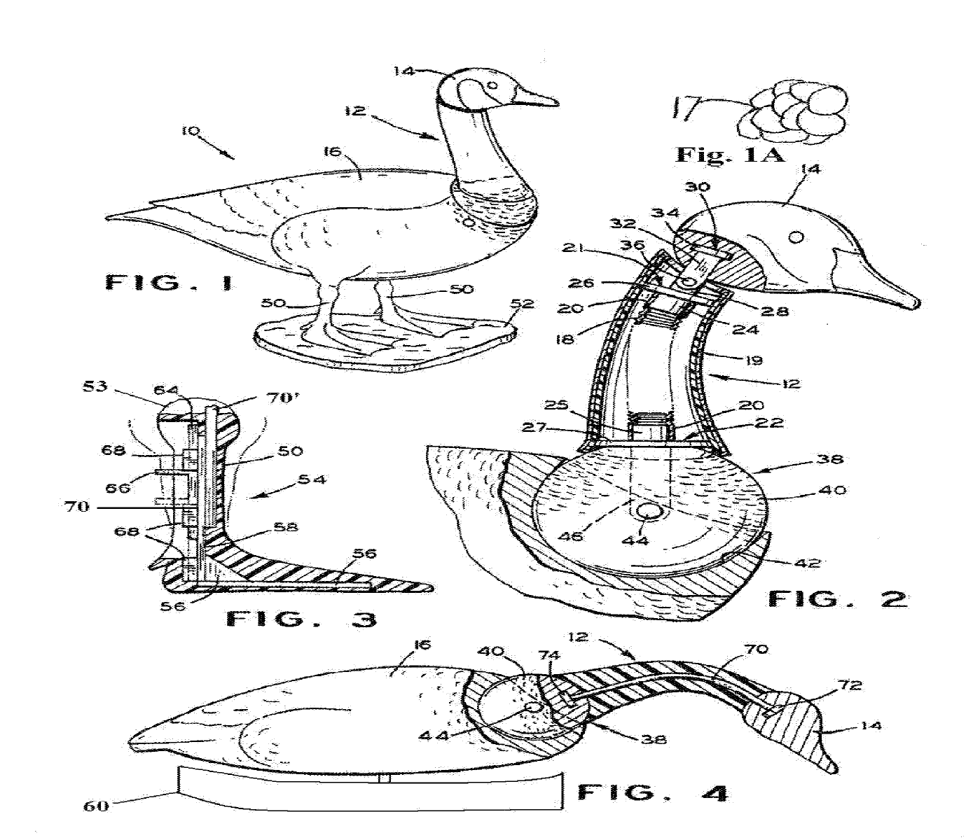

A first embodiment of the realistic decoy of the present invention is depicted in FIGS. 1 generally at 10. The decoy illustrated is a waterfowl, more particularly a goose decoy, including a neck assembly shown generally at 12, which interconnects a head 14 and a body 16. The head 14 and body 16 may be solid molded members, for example of a foamed plastic material. Another suitable form of body construction is shown and described in my earlier U.S. Pat. No. 4,890,408, the disclosure of which is incorporated herein by reference.

Faux feathers 17 of the type depicted in FIG. 1A, commonly used on hats and other items of apparel, can be used to adorn the exterior of at least a portion, and preferably all of the “above water” exterior of the decoy body 16. These fake feathers 17 can be attached using a water-proof adhesive. In addition, faux feathers 17 can be utilized, in smaller sized feathers, to cover portions or all of both neck 12 and head 14 to provide a more realistic appearance to decoy 10.

In the embodiment of FIG. 2 the neck assembly comprises a deformable tubular support member 18 disposed within a flexible sleeve 19. The support member 18 may suitably comprise any of a number of well-known products which may be readily manually deformed or bent and which will retain the shape to which they are bent. In the embodiment of FIG. 2 the member 18 comprises a malleable helical wire within a supple plastic sheath as of polypropylene such as is used as pliable duct work. Other suitable materials will be hereinafter described.

The tubular support member 18 is provided with molded cuffs 20 at its opposite ends. Similar mounting brackets, shown generally at 21 and 22, are affixed at the head end and the body end, respectively, and position the head in any desired attitude relative to support member by means of bosses 24 and 25 received within the respective cuffs. The mounting brackets 21 and 22 include circumferential spacer flanges 26 and 27, respectively, of such diameter that their peripheral edge engages the inner wall of the sleeve 19 to position the mounting brackets 21 and 22 axially within the sleeve.

The head end mounting bracket 21 includes a hinge leaf 28 for hingedly connecting the mounting bracket to a head anchor 30. The head anchor comprises a hinge leaf 32 affixed to a base plate 34 secured to, or imbedded within, the head 14 as by being integrally molded therein, and pivotally coupled to the corresponding hinge leaf 28 by a hinge pin 36. The hinge leaf may alternatively extend into the head for positioning the hinge pin within the head, if desired.

In order to simulate the anatomy of the waterfowl and provide a more realistic appearance as the configuration is adjusted between poses, the tubular support member 18 is affixed to the body 16 by means of a modified ball-and socket-arrangement shown generally at 38.

More particularly, a rotatable insert 40 roughly in the form of an oblate spheroid is received within a correspondingly shaped recess 42 formed in the breast or chest area of the decoy. The insert is mounted upon a shaft,” carried at its ends in the body 16 encompassing the end portions of the insert 40, so as to be rotatable about its longitudinal axis. The body end mounting bracket 22 may include a hinge leaf 46 which extends into the insert 40 and is coupled to the shaft 44 for the support member 18 to the body. Of course, the neck assembly 12 may be affixed to the insert 40 in other suitable ways.

The hinged connections are conventionally constructed with sufficient frictional engagement between the members for the hinges to be readily manually deflected and to remain in any angular position at which they are set. Thus, as will be readily apparent, the angular attitude of the base of the neck relative to the body 16 and of the head 14 relative to the neck, can be adjusted in conjunction with the manipulation of the neck 20 configuration itself to achieve various realistic poses.

A pliable covering 48 may cover the outer surface of the sleeve 19 and extend to the insert 40. The insert is textured on its outer surface so as to merge with the outer covering of the body. The covering 48 is suitably textured and colored as indicated in FIG. 1 to match the markings of a selected one of the many waterfowl species. The head 14 and the body 16 are similarly painted to resemble the markings of the selected species. Alternatively, the exterior of the head 14 and body 16 may be adorned with faux feathers 17 depicted in FIG. 1A to achieve a more realistic appearance.

In use, the neck assembly 12 and the head 14 may be moved relative to the body 16. The hinged connections move with a slight friction which allows them to be operated, yet retain their position to support the neck 12 and the head 14 of the decoy when released. Additionally, the tubular support member 18 may be flexed to bend the neck 12 into a selected lifelike posture. The support member 18 will hold the shape into which it is manipulated, and thus the decoy 10 may be suitably arranged to assume various lifelike poses. Since the point at which the lower end of the neck assembly 12 pivots is effectively located within the breast of the decoy, the neck motion more nearly simulates that of an actual goose and gives a very natural appearance when the neck is lowered.

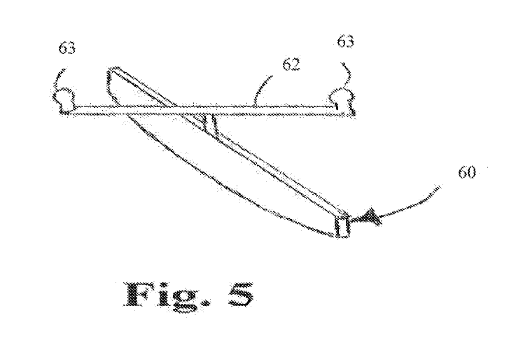

As illustrated in FIG. 1, the body 16 of the decoy assembly 10 may be provided with a removable legs 50 for support when the decoy is to be deployed on land. If the decoy is of a two legged game animal, such as the goose decoy illustrated, the feet of the decoy may be attached to a supporting base or platform 52 to maintain the decoy erect. Most preferably, upper ends 51 of each leg 50 is provided with an oblate spheroid 53 of plastic, steel or aluminum that snaps into a complementarily shaped recess 18′ in body portion 16 in the manner of a pop bead. The decoy assembly 10 also includes a keel 60 (FIG. 5) which is secured by a oblate spheroid of the type used to attach legs 50. Alternatively, as depicted in FIG. 5, keel 60 has a transverse mounting beam 62 with least two oblate spheroid 63 which in like manner, can be alternatively snapped into recesses 18′ in body portion 12. In this manner, decoy assembly 10 can be configured for use in both land and water applications.

In order to further enhance the realistic appearance of the decoys when deployed on land, they may be provided with a flexible leg construction which allows the decoy to rock back and forth in response to the wind to simulate a walking or feeding motion. To that end, as shown in FIG. 3 there may be embedded in the legs 50 a suitable flexing joint, shown generally at 54, which may selectively hold the body in a rigid erect stance, or allow it to rock forwardly and rearwardly about the feet on the base 52 in response to an applied force as from the wind or by means of a line (not shown) extending to a remote blind in which a hunter is concealed.

The flexing joint may comprise a plate member 56 disposed in the foot portion of the leg 50 and affixed to an upstanding flexible strut 58 which may be a strip of spring steel. The flexible strut overlaps and is affixed to a lower end of malleable wire 70 which is embedded in and extends upwardly through the leg 50. Malleable wire 70 may be reshaped to place the body 16 of goose 10 in a position consistent with the positions the head is placed in by flexible neck 12, positions for performing one action selected from the group consisting of i) feeding, ii) sleeping, iii) standing, iv) swimming and v) preening. Spring steel 70 causes the decoy 20 to sway in the wind (see dotted line positions) simulating movement of a real waterfowl. A latch bar 64 having a grasping extension 66 is mounted for axial sliding movement within a plurality of U-shaped straps 68 affixed to the flexible strut 58. The material forming the leg 50 and covering the flexible joint 54 is likewise flexible and is open at the rear so that the extension 66 can be grasped for axially sliding the latch bar 64 within the straps 68. Thus, the latch bar may be selectively moved between the position shown in solid lines in FIG. 3, wherein the joint may flex above the plate member 56 and the position shown in broken lines wherein the latch bar is engaged within the lower strap 68 to prevent movement of the decoy by the spring steel 70.

There is shown in FIG. 4 an alternate embodiment of the invention, providing a somewhat simplified construction, wherein the neck assembly 12 comprises a malleable wire 70 provided at one end with an anchor flange 72 for embedding in the decoy's head 14. The wire 70 is provided at the other end with an anchor flange 74 for embedding in the rotatable insert 40. Of course, other and different means may be conventionally provided for securing the wire to the rotatable insert and the head. A flexible outer sheath portion 76 surrounds the wire 70 between the head 14 and the rotatable insert. The outer portion 76 is preferably formed of a soft, closed cell foamed plastic material, and may be formed with a suitably textured outer surface. Such products are, for example, conventionally employed as hair curlers. The outer surface of the sheath 76, and the remainder of the decoy 10, are textured and colored to resemble the markings of a selected one of the many game animal species. The neck 11 may be suitably bent and the insert 40 rotated to position the head 14 relative to the body 16, and the wire 70 will support the head 14 when the decoy 10 is deployed.

The invention as depicted in FIG. 4 graphically illustrates the more natural configuration of the neck and head of the decoy in a feeding position made possible by mounting the neck upon the rotatable insert 40. In addition to being flexible, the neck can thus be pivoted about its base in the chest or breast area in a manner very similar to that which occurs in the actual animal or fowl. Also shown in FIG. 4 is a removable keel 60. This feature is usable with all the embodiments taught herein. The legs 50, used when the decoy is deployed on land, are removed by extracting pop-beads 51 from their orifices and inserting beads 63 which extend upwardly from bar 62 to mount keel 60 (FIG. 5) to the bottom of decoy body 16. Decoy 10 of the present invention may alternatively be used for both land and water applications, saving hunters the expense of making multiple purchases.

In still another embodiment the neck may comprise a conventional plastic material with memory, such as employed in reconfigurable toys. The plastic material may thus be molded in the form of the neck 12 as illustrated in FIG. 4, but without the necessity for the malleable wire 70, and suitably affixed to the head 14 and the rotatable insert 40, for example, by use of an adhesive or internal dowels. The neck 12 may have a suitably textured outer surface, or may be provided with a separate outer covering having a suitably textured outer surface. The neck 12 may thus be suitably bent and the insert 40 rotated to position the decoy 10 in a lifelike pose, and the plastic material will remain in the selected position until the neck is suitably repositioned to another pose.

The realistic decoy 20 of the present invention may be adapted for use on land using the removable legs or, alternatively, oblate spheroids 63 of keel 60 may be inserted into recesses 18′ to equip decoy 20 for use in bodies of water. Decoy 20 is believed to be the only decoy available on the market with such capabilities.

Various changes, alternatives, and modifications will become apparent to a person of ordinary skill in the art after a reading of the foregoing specification. For example, it will be understood that the body of the decoy may be blow molded and/or burlap-wrapped which is a feature of other commonly owned patents/patent applications. It is intended that all such changes, alternatives, and modifications as fall within the scope of the appended claims be considered part of the present invention.

I claim:

1. A decoy for luring waterfowl within a hunter's range, said decoy comprising:
a) a body portion at least a portion of which is covered with faux feathers enhancing its similarity of physical appearance to an actual water fowl;
b) a head portion interconnected to said body portion by a flexible neck which can be bent to place said head portion in a particular desired orientation emulating an actual waterfowl's head positioning when performing one action selected from the group consisting of i) feeding, ii) sleeping, iii) standing, iv) swimming and v) preening;
c) a base portion interconnected to said body portion by a plurality of spring steel members allowing gusts of wind to rock said decoy in a life-like manner.

2. The decoy of claim 1 wherein said flexible neck is connected to said body portion by a modified ball-and-socket positioned in a chest portion of said decoy.

3. The decoy of claim 1 wherein said base portion can be removed and replaced by a keel configuring said decoy for use on a body of water.

4. The decoy of claim 1 wherein said base portion includes a plurality of flexible legs which may be configured in a plurality of positions consistent to said desired orientations of said head portion.

5. The decoy of claim 4 wherein said flexible section further comprises latching means to selectively inhibit said rocking motion.

6. A decoy assembly for luring waterfowl within a hunter's range said decoy assembly being adaptable for use on land and water, said decoy assembly comprising:
a) a body portion having an appearance of a waterfowl, said body portion having at least one socket for receiving and retaining at least one removable protrusion;
b) a head portion repositionable upon said body portion to simulate a variety of activities normally engaged in by the waterfowl;
c) a base portion simulating legs of a waterfowl, said base portion having a first said at least one protrusion for engagement in said socket;
d) a keel portion for stabilizing said body portion on a body of water, said keel portion having a second said at least one protrusion for alternative engagement in said socket;
whereby said decoy may be adapted for use on land and on water.

7. The decoy assembly of claim 6 further comprising a flexible neck interconnecting said head portion to said body portion, said flexible neck facilitating repositioning of said head portion into a variety of positions.

8. The decoy assembly of claim 7 further comprising faux feathers attached to at least a some of said body portion, said head portion and said neck portion to enhance the similarity of physical appearance of said decoy to an actual water fowl.

9. The decoy of claim 7 wherein said flexible neck is connected to said body portion by a modified ball-and-socket positioned in a chest portion of said decoy.

10. The decoy of claim 6 wherein said base portion includes a flexible section permitting wind-induced rocking motion.
